(19) United States
(12) Patent Application Publication
(10) Pub. No.: US 2025/0142501 A1
(43) Pub. Date: May 1, 2025

(54) SYNTONISATION OF SIGNALS BETWEEN SATELLITES

(71) Applicant: EUROPEAN SPACE AGENCY (ESA), Paris (FR)

(72) Inventors: Manuel MARTIN NEIRA, AZ Noordwijk (NL); Volodymyr KUDRIASHOV, AZ Noordwijk (NL); Natanael AYLLON ROZAS, AZ Noordwijk (NL)

(21) Appl. No.: 18/835,304

(22) PCT Filed: Feb. 7, 2022
(86) PCT No.: PCT/EP2022/052898

§ 371 Date: Aug. 1, 2024

(51) Int. Cl. H04W 56/00; H04B 7/185

(52) U.S. Cl. CPC H04W 56/0035; H04B 7/18521

(57) ABSTRACT

A space or aerial vehicle may be configured to generate an internal signal having a frequency which is syntonised with the frequency of the internal signal generated by a second vehicle. The vehicle may comprise a master oscillator configured to oscillate at a nominal frequency and to generate an oscillator signal (F₁) at the nominal frequency, a receiver (Rx-1) configured to receive an inter-vehicle signal, wherein the inter-vehicle signal is generated by the second vehicle by modulating a carrier (C₂) with a second oscillator signal (F₂), wherein the second oscillator signal is generated by a second master oscillator of the second vehicle configured to oscillate at the nominal frequency. Signal processing circuitry may be provided to demodulate the received inter-vehicle signal to obtain a demodulated signal comprising a received version of the second oscillator signal (F′₂), and to generate the internal signal based on a sum frequency comprising the first oscillator signal (F₁) and the received version of the second oscillator signal (F′₂) as summands.

### FIELD OF THE INVENTION

The invention relates to a vehicle, such as a space vehicle or an aerial vehicle, which is configured to generate an oscillator signal using a master oscillator, wherein the master oscillator is configured to oscillate at a nominal frequency. The invention further relates to a system of vehicles. The invention further relates to a method of generating an oscillator signal using a master oscillator at a vehicle.

### BACKGROUND ART

There are many space applications in which a number of satellites cooperate, for example in radio astronomy (e.g., Very Long Baseline Interferometry), remote sensing (e.g., Synthetic Aperture Radar Interferometry or Passive Aperture Synthesis) or to generate navigation signals (e.g., Global Navigation Satellite System). In such cooperative space applications, there may be need for a common clock amongst the satellites, which clock may be used for various purposes, e.g., for timing or control. For that purpose, each satellite may comprise an onboard oscillator which may be configured to oscillate at a nominal frequency and which nominal frequency may be chosen to be the same for all satellites. However, the onboard oscillator may be unable to oscillate at precisely the nominal frequency, e.g., due to aging or due to tolerances in its internal components. Nevertheless, many space applications require the oscillator signals generated at each satellite to have a very similar frequency. Trying to reach such similarity in frequency is also referred to as syntonisation.

It is known provide an atomic clock with extreme frequency stability in a satellite to try to reach syntonisation between satellites. However, this approach may still be insufficient for some applications, for example when imaging the event horizon of the super-massive black hole in the centre of our galaxy. In this imaging example, even when providing the best active hydrogen masers as atomic clocks aboard satellites, the level of syntonisation would allow integration times of only a few tens of seconds, while several minutes would be required to achieve sufficient sensitivity.

It is also known to syntonise the oscillators onboard the satellites in other ways. For example, in [1], the onboard oscillators were steered to GNSS time and frequency. However, such an approach does not provide the necessary precision in syntonisation. Other known approaches involved using inter-satellite links for syntonisation. For example, in [2], an inter-satellite link was established by bidirectional transmission of very narrow laser pulses, and in [3], a master-slave approach was used in which one satellite functioned as ‘master’ and others as slaves.

Disadvantageously, satellites normally exhibit relative movement with respect to each other, which means that inter-satellite signals are subject to Doppler shifts. Such Doppler shifts may hinder syntonisation using inter-satellite signals. While it is known to try to correct for such Doppler shifts, e.g., as in [3], such correction may be complex and ultimately insufficiently accurate for many space applications.

Such Doppler shifts and syntonisation problems may exist as well between other vehicles besides satellites, e.g., between non-orbital space vehicles, or between aerial vehicles, e.g., in unmanned aerial vehicles (UAVs) such as drones.

### REFERENCES

[1] N. Gebert, “SAOCOM-CS Timing”, Microwave Instrument Forum 1, 27-10-2016
[2] C. Günther, “Kepler-Satellite Navigation without Clocks and Ground Infrastructure”, ION-18 Conference.
[3] M. Toissant et al., “Synchronisation concepts, technology and performance for Bistatic SAR Missions”, 2017

### SUMMARY OF THE INVENTION

An object of the invention is to provide a syntonisation mechanism between vehicles which addresses at least one of the problems identified above.

A first aspect of the invention provides a vehicle as defined by claim 1. A further aspect of the invention provides a method as defined by claim 15.

To further explain the measures provided by the above identified claims, this section refers to a satellite as an example of a vehicle as claimed, with the understanding that the above measures equally apply to other space vehicles besides satellites, as well as to aerial vehicles, or in general to any entities which move relative to each other and between which entities syntonisation is desired. In addition, the following refers to syntonisation between two satellites, with the understanding that the above measures equally apply to systems comprising more than two satellites. Finally, it is to be understood that references to ‘syntonisation’ or ‘syntonised’ may refer to such syntonisation being achieved to a high degree, e.g., higher than in prior art syntonisation schemes, but does not imply that the syntonisation is 100% precise.

In accordance with the above measures, in each satellite, the claimed functionality is provided, by which a master oscillator is provided which is set to oscillate at a nominal frequency. Such oscillators may take any form known per se, including but not limited to crystal oscillators and atomic clocks. It is expected that the master oscillator may not achieve oscillation at precisely the nominal frequency. As such, the frequency of the signal generated by the master oscillator aboard each satellite may deviate slightly from the nominal frequency, and thereby from one satellite to the other, as the deviation is unlikely to be the same in each satellite. This may be problematic for the reasons previously indicated in the background section.

In accordance with the above measures, syntonisation between the multiple satellites may be provided by the satellites ‘swapping’ their oscillator signals. Namely, in the example of syntonisation between a first satellite and a second satellite, the second satellite may be configured to modulate a carrier with its locally generated oscillator signal, which may henceforth be denoted as F₂, and transmit the modulated signal to the first satellite, where it may be received and demodulated to obtain F₂, i.e., a received version of the second satellite's local oscillator signal F₂. The first satellite may further generate its own local oscillator signal, which may henceforth be denoted as F₁, and transmit this local oscillator signal in modulated form to the second satellite.

Each satellite may therefore obtain its own local oscillator signal and a received version of the other satellite's oscillator signal. The latter is likely to deviate from the local oscillator signal due to i) a slight difference in the oscillating frequency between both satellites, i.e., F₁≈F₂, for example due to aging or tolerances in the oscillator's components, and ii) a Doppler shift between the first and second satellite due to their relative movement. Due to the Doppler shift, the received version of a satellite's oscillator signal may differ from the oscillator signal at the transmitting satellite, which received version is elsewhere denoted by a prime symbol ‘.

By such swapping of oscillator signals, at the first satellite, signals F₁ and F₂ may be available, while at the second satellite, signals F’ and F₂ may be available. As the Doppler shift may affect the signal transmitted from the first satellite to the second satellite in substantially the same manner as the signal transmitted from the second satellite to the first satellite, the sum frequencies of both signals (i.e., local and received) at each satellite may be substantially the same. Providing substantially the same Doppler shift at each receiving satellite may also be referred to as Doppler balancing. By then generating a signal at each satellite based on a sum frequency of both the local oscillator signal as first summand and the received version of the other oscillator signal as a second summand, a signal may be generated in which not only the difference in oscillating frequency may be eliminated as a factor in the de-syntonisation between the satellites, but also the Doppler shift between the satellites may be balanced-out. The sum frequency may thus represent a syntonised frequency component, which may be used at each satellite as an internal signal for further processing, for example for use as a common clock in a cooperative space application.

As indicated elsewhere, the swapping of oscillator signals also applies to more than two satellites, in which case at a respective satellite, the local oscillator signal and the received versions of other satellite's oscillator signals are available, for example by each satellite transmitting each local oscillator signal directly to each of the other satellites, or by the satellites forming a transmission loop in which the local oscillator signals are relayed from one satellite to another, e.g., in a clockwise and/or counter-clock wise direction. Also here, the sum frequency of the local signal and the received versions of the other oscillator signals will be substantially the same at each satellite as the Doppler shift which is experienced when satellite 1 transmits its local oscillator signal to satellite N, either directly or by relay, will be substantially the same as the Doppler shift which is experienced when satellite N transmits its local oscillator signal to satellite 1. Thereby, each of the satellites is enabled to generate a sum frequency which represents a syntonised frequency component amongst all satellites.

The above measures thus pertain to the swapping of signals of frequencies derived from the local master oscillators between satellites. The received frequencies are affected by the Doppler shift due to the relative motion between the satellites. However, assuming that the nominal frequency of the master oscillators is the substantially same on each satellite (with only small deviations, for example due to aging), the Doppler shift is the same each way (except for a negligibly small term).

Advantageously, when using the above measures to syntonise satellites, the local master oscillators do not need to be highly stable in order to achieve precise syntonisation. For example, syntonisation may be achieved regardless of using crystal oscillators or atomic clocks as master oscillators. This may make the syntonisation more cost-effective. Moreover, the syntonisation may be kept over an exceptionally large range of time scales, from a small fraction of a second to years, which may not be possible when using independent state-of-the-art atomic clocks aboard the satellites. In this respect, it is noted that the absolute stability of the sum frequencies does depend on that of the master oscillators. Namely, if the frequencies of the master oscillators change over time, the sum frequency will reflect such changes, but the sum frequencies at the different satellites will remain very similar to each other, keeping the satellites syntonised. Advantageously, the above measures provide syntonisation which is sufficiently precise for demanding cooperative satellite applications, such as radio astronomy (e.g., the forementioned Very Long Baseline Interferometry).

In an embodiment, the signal processing circuitry is configured to generate the sum frequency while attenuating harmonics of either summand in the sum frequency. For example, the signal processing circuitry may be configured to generate the sum frequency using double balanced mixers and upper side band filters to attenuate the harmonics of either summand in the sum frequency.

In a specific example, the signal processing circuitry may comprise a module (USBS-2) for use in generating the internal signal, wherein the module is configured to generate a frequency-multiplied sum frequency for a first input signal as a first summand and a second input signal as a second summand by:
frequency-multiplying the first input signal (F₁) by a first multiplier value (P), which first multiplier value is a natural number larger than one, to obtain a frequency-multiplied first input signal (PF₁);
frequency-multiplying the second input signal (F₂′) by a second multiplier value (P−1), which second multiplier value equals the first multiplier value minus one, to obtain a frequency-multiplied second input signal ((P−1)F₂′);
mixing the frequency-multiplied first input signal (PF₁) with the second input signal (F₂′) and applying an upper side band filter to an output of said mixing to obtain an intermediate upper side band-filtered signal (PF₁+F₂′); and
mixing the intermediate upper side band-filtered signal (PF₁+F₂′) with the frequency-multiplied second input signal ((P−1)F₂′) and applying an upper side band filter to an output of said mixing to obtain the frequency-multiplied sum frequency (P(F₁+F₂′)).

The above module may be a physically separate signal processing circuitry but may typically be part of the overall signal processing circuitry of the satellite and thus represent a functional module rather than a physical separate module.

As explained elsewhere, the syntonisation between satellites is based on Doppler balancing. Such Doppler balancing is possible if substantially the same frequency is exchanged between the satellites. However, this poses a problem to the subsequent summation of the local and the remote oscillator signals, as the harmonics of the input signals to the summation, i.e., the oscillator signals, may fall on the desired output frequency, i.e., on the sum term. To avoid this problem, one may use master oscillators at different frequencies so that the wanted sum frequency can be easily band pass filtered from the harmonics. However, this may lead to a difference between the output frequencies generated by the unbalanced Doppler shift over the inter-satellite link. This may be acceptable, for example when the Doppler shift is deemed to be small or when additional Doppler correction is applied. However, such a difference may be avoided by using the above-identified module comprising double balanced mixers and upper side band filters to attenuate unwanted harmonics. This module may be straightforward in implement since such double balanced mixers are available as standard microwave components. While the output is a frequency multiplied sum frequency, i.e., multiplied by a factor P, this may be acceptable when using the frequency multiplied sum frequency as a common clock, e.g., by anticipating in the space application for such frequency multiplication, or by using frequency dividers, etc.

In an embodiment, the signal processing circuitry is configured to generate the frequency-multiplied sum frequency (P(F₁+F₂′)) using the first oscillator signal (F₁) as the first input signal and the received version of the second oscillator signal (F₂′) as the second input signal. This way, the output of the module may be a frequency-multiplied sum frequency of the first oscillator signal and the received version of the second oscillator signal. This frequency-multiplied sum frequency P (F₁+F₂′)) may be used in each satellite as the syntonised internal signal for application purposes.

In an embodiment, the vehicle further comprises a transmitter (Tx-1) configured to transmit a second inter-vehicle signal to the second vehicle, wherein the signal processing circuitry is configured to generate the second inter-vehicle signal by modulating a carrier (C₁) with the first oscillator signal (F₁). Each satellite, or in general each vehicle, may be configured to both transmit and receive an inter-vehicle signal, and in particular to transmit its own oscillator signal in modulated form and to receive the oscillator signal of other satellite(s) in modulated form. In this respect, it is noted that the demodulation at each satellite may extract the remote oscillator signal from the received modulated signal, preferably without using frequencies generated at the receiving satellite as the use of such local frequencies may disturb the syntonisation. Avoiding the use of local frequencies when demodulating a modulated signal is known per se, and any suitable technique may be used, including but not limited to recovering the carrier from the modulated signal, or when amplitude modulation is used, using an amplitude detector, or when intensity modulation is used, using a power detector, etc.

In an embodiment, the carrier (C₁) used by the vehicle is different from the carrier (C₂) used by the second vehicle, for example in frequency. Here and elsewhere, the term ‘carrier’ is understood to refer to a carrier signal. By using different carriers, different satellites may transmit their local oscillator signals simultaneously, e.g., on a continuous basis or in overlapping transmission windows. It is therefore not needed for the transmission of the satellites to be time alternating and therefore synchronized in time. Alternatively, the transmission by the satellites may be synchronized in time, in that each satellite may transmit in a transmission window which is non-overlapping with that of another satellites. This way, a same carrier may be used at each satellite, e.g., in terms of frequency. For example, the transmission windows may be synchronized in time amongst the satellites by defining a transmission scheme relative to GNSS time. In an embodiment, the vehicle is configured to receive an inter-vehicle signal of a third vehicle, wherein the received inter-vehicle signal is generated by the third vehicle by modulating a carrier (C₃) with a third oscillator signal (F₃) generated by a third master oscillator, and wherein the signal processing circuitry is further configured to generate the internal signal based on the sum frequency (F₁+F₂′+F₃′) comprising the first oscillator signal (F₁), the received version of the second oscillator signal (F₂′) and a received version of the third oscillator signal (F₃′) as summands.

As indicated elsewhere, the syntonisation also applies to three or more satellites. In such a case, at each satellite, the local oscillator signal is available and the Doppler-shifted received versions of other satellite's oscillator signals may be received, either directly from a respective satellite and/or by relay via another satellites. The sum frequency term may thus be extended by the received versions of the oscillator signals of the other satellites. At each satellite, the total contribution of the Doppler shift in the sum frequency may be substantially the same, thereby establishing Doppler balancing.

In an embodiment, the signal processing circuitry is configured to generate the sum frequency (F₁+F₂′+F₃′) by using the module (USBS-2) with pairs of oscillator signals of master oscillators of different vehicles as input to obtain respective intermediate outputs and to repeatedly use the module with pairs of previous intermediate outputs so as to obtain the sum frequency as output. The aforementioned ‘USBS-2’ module may be used to generate a sum frequency term of two input signals while attenuating undesired harmonics of the input signals in the output signal. When syntonising three or more satellites, more than two input signals need to be summed. Accordingly, the module may be used to sum pairs of input signals and then again to sum their output signals, in a binary tree manner, until one output signal is obtained, with this output signal representing the sum frequency of all input signals.

In an embodiment, the signal processing circuitry is configured to frequency-divide each output of the module (USBS-2) by the first multiplier value (P). It may be preferred to frequency-divide each output of the module so as to avoid, when applying the module iteratively in a binary-tree manner, generating a frequency-multiplied sum frequency in which the frequency multiplication factor is too high.

In an embodiment, the inter-vehicle signal of the third vehicle is received directly from the third vehicle or is received by relay via the second vehicle. In the relay case, the inter-vehicle signal of the third vehicle may thus be relayed via at least the second vehicle. Here, the ‘at least’ refers to the possibility that the inter-vehicle signal may be relayed via more than one vehicle, for example via a fourth, fifth, etc. vehicle. In an embodiment, syntonisation is carried out between a plurality of more than three vehicles, wherein the first vehicle receives an inter-vehicle signal of a particular other vehicle directly from the other vehicle or by relay via one or more intermediate vehicles. In such embodiments, an inter-vehicle signal may be relayed via one or more intermediate vehicles before it is received by the first vehicle, with the adjective ‘intermediate’ referring to a particular vehicle forming an intermediate link in a relaying chain by which the inter-vehicle signal is relayed from a source to a destination. It is noted that the plurality of vehicles may form a loop in which each vehicle may act as relay for inter-vehicle signals of other vehicles, for example to establish a relay of inter-vehicle signals in clockwise and counter-clockwise direction through the loop. Such relaying using a loop is an efficient way of ensuring that each vehicle receives the inter-vehicle signal of each other vehicle of the plurality of vehicles. Advantageously, when forming a relay loop between the vehicles, it is noted needed for each vehicle to be in signalling range with each of the other vehicles.

In an embodiment, the first multiplier value (P) is an even number. While any multiplier value may be selected which is a natural number larger than one, better suppression of undesired harmonics may be obtained for even multiplier numbers.

In an embodiment, the inter-vehicle signal is an optical signal or a radio-frequency signal.

In an embodiment, the vehicle is a space vehicle, such as a satellite, or an aerial vehicle, such as an unmanned aerial vehicle. An example of an unmanned aerial vehicle is a drone.

It will be appreciated that any embodiment of a vehicle or its circuitry implies a corresponding embodiment of a corresponding method, and vice versa.

It will be appreciated by those skilled in the art that two or more of the above-mentioned embodiments, implementations, and/or aspects of the invention may be combined in any way deemed useful. Modifications and variations of any entity described in this specification, e.g., any vehicle, circuitry, or method, which correspond to the described modifications and variations of another one of these entities may be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 shows a block diagram of the syntonisation circuitry in a first satellite SAT-1 and the same type of syntonisation circuitry in a second satellite SAT-2;

FIG. 2A shows the frequency of interest (normalised to F₀) and the most harmful harmonics and inter-modulation products for values of P=2,3,4 at the output of mixer MIX-A, with desired signals shown in light-grey cell shading and underlined and harmful harmonics and inter-modulation products in darker-grey cell shading;

FIG. 2B is similar to FIG. 2A but shows the output of mixer MIX-B;

FIG. 3 illustrates a constellation of N satellites, in which a loop (partially shown in FIG. 3) is formed for transmission of signals between the satellites;

FIG. 4 shows an USBS-2 module configured to generate a frequency-multiplied sum frequency for a first input signal and a second input signal, in which sum frequency the harmonics of the first and second input signals are attenuated;

FIG. 5 shows a block diagram of the syntonisation circuitry in a first satellite SAT-1 for syntonisation amongst N satellites;

FIG. 6 shows examples of (top) the spectra of the inter-satellite links showing the separation between transmission and reception bands and (bottom) the spectrum, within the transmission band, showing the N−1 carriers Cᵢ with the corresponding modulating frequencies Fᵢ;

FIG. 7 shows examples of arrangements of transmission windows: non-overlapping uniform transmission windows (left) and fully overlapping transmission windows (right); and

FIG. 8 shows a block diagram of the syntonisation circuitry in the first satellite SAT-1 which is configured for syntonisation with N satellites using one-to-all transmissions, in which in each satellite disciplined oscillators are used following the demodulators and in which the transmitter and receiver of a respective satellite is activated only during a time window assigned to the respective satellite.

It should be noted that items which have the same reference numbers in different figures, have the same structural features and the same functions, or are the same signals. Where the function and/or structure of such an item has been explained, there is no necessity for repeated explanation thereof in the detailed description.

### List of Reference and Abbreviations

The following list of references and abbreviations is provided for facilitating the interpretation of the drawings and shall not be construed as limiting the claims.

| CCW | counter-clockwise |
|---|---|
| CW | clockwise |
| DEM | demodulator |
| ISL | inter-satellite link |
| MIX | mixer |
| MOD | modulator |
| SAT | satellite |
| TB | transmission band |
| USB | upper side band |
| USBS | upper side band syntonisation circuitry |
| 100 | syntonisation circuitry |

### DETAILED DESCRIPTION OF EMBODIMENTS

The following describes several embodiments of syntonisation amongst satellites. However, these embodiments equally apply to other space vehicles besides satellites, as well as to aerial vehicles, or in general to any entities which move relative to each other and between which entities syntonisation is desired. As such, any reference to ‘satellite’, ‘inter-satellite signal’, ‘inter-satellite link’, etc. is to be understood as equally referring to any of such other entities. The following describes, under the heading ‘A’, embodiments involving the syntonisation of two satellites, and under the heading ‘B’ and ‘C’, embodiments involving the syntonisation of N>2 satellites, with embodiments B and embodiments C comprising two different transmission concepts. It will be appreciated that embodiments and aspects of embodiments may be combined.

### A) Two-Satellite Syntonisation

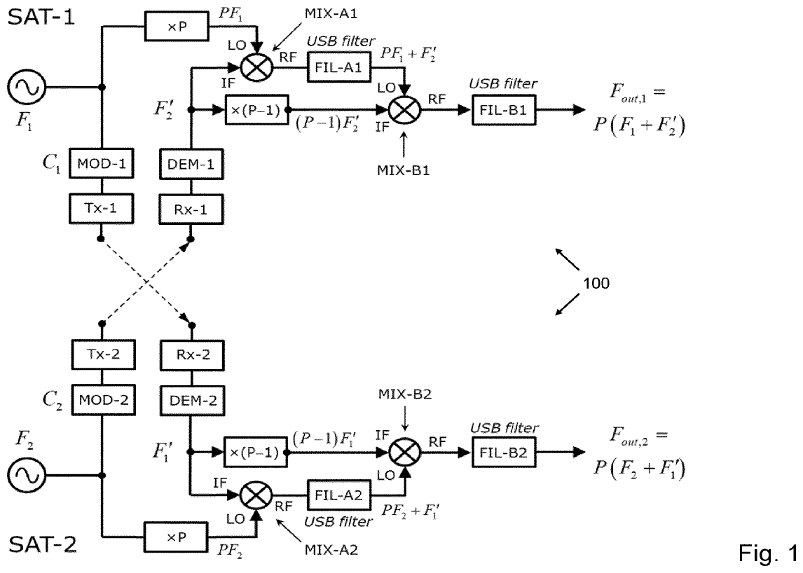

The following refers to FIG. 1 which shows a block diagram for two-satellite syntonisation, in which two satellites SAT-1 and SAT-2 are to be syntonised. In particular, FIG. 1 shows an example of syntonisation circuitry 100 aboard each satellite, which syntonisation circuitry are together configured to produce extremely similar frequencies at their respective outputs. The block diagram of SAT-2 is symmetric to that of SAT-1. It is noted that the block diagram of FIG. 1 is exemplary and that many alternatives are within reach of the skilled person on basis of the present disclosure.

On SAT-1, the signal of a master oscillator oscillating at F₁ is split in two paths. In one path, the local oscillator signal F₁ is frequency-multiplied by a factor P>1 and converted into an oscillation of frequency P×F₁. In the second path, the signal from the master oscillator enters a modulator MOD-1 to modulate a carrier C₁. The modulated signal enters transmitter Tx-1 and is sent over an inter-satellite link (ISL) towards the second satellite, SAT-2. This transmission may for example be performed in the radio frequency (RF) domain or optically, i.e., in the optical domain.

SAT-1 has a receiver Rx-1 which receives the corresponding carrier C₂ transmitted by SAT-2 and which is modulated with the local oscillator signal of frequency F₂ of the master oscillator of SAT-2. Whenever there is a radial velocity between the two satellites, which is generally the case, the carrier and modulation signal from SAT-2 as received by SAT-1 may be Doppler shifted. The received frequencies, C₂′ and F₂′, are therefore slightly different from the transmitted ones, C₂ and F₂, where the primes denote the disturbance by the Doppler shift.

The output of receiver Rx-1 enters a demodulator DEM-1 which recovers the signal F₂′ corresponding to the modulating frequency. The output of the demodulator may elsewhere also simply be referred to as ‘frequency’ of a satellite, with the understanding that this refers to a demodulated signal having this frequency.

Preferably, the demodulator DEM-1 uses a demodulation scheme which allows to recover the modulating signal at F₂′ without the need of using the carrier C₁, or any other frequency locally generated in vehicle 1, for demodulation, as otherwise the recovered modulating frequency F₂′ would be affected by a frequency offset between the carriers C₁ and C₂′. This is possible, for example, with a demodulator which recovers the carrier C₂′ and uses the recovered carrier to extract the modulating frequency F₂′. Other options include but are not limited to using amplitude modulation and using an amplitude detector in the demodulator, or using intensity modulation and using a power detector in the demodulator, etc.

The P×F₁ tone, i.e., signal, is mixed with the recovered modulation signal from SAT-2 at frequency F₂′ in mixer MIX-A1. The Upper Side Band (USB) at P×F₁+F₂′ is selected by an USB filter FIL-A1 at the output of MIX-A1 and mixed in mixer MIX-B1 with a (P−1)-frequency multiplied version of the received modulation signal at F₂′.

The USB at the output of MIX-B1 is selected by a second USB filter FIL-B1 as desired output frequency Fₒᵤₜ=P×(F₁+F₂′). The output signal Fₒᵤₜ may then be used for application purposes, e.g., as a common clock in cooperative space applications.

### Level of Syntonisation

In the short time scales of the flight time of signals from one satellite to another (which is elsewhere also referred to as an inter-satellite link, in short ISL), which may typically be in the order of milliseconds, there may be phase noise in the received signals, and the correlated component of the phase noise may dominate. Therefore, the phase fluctuations in the output signals of the syntonisation circuitries of the two satellites may be highly correlated, and may thus be coherent, regardless of the value chosen for the parameter P, i.e., the frequency multiplication factor.

At the longer time scales of seconds, hours or days, the coherence of the output signals may be compromised by frequency evolution. The frequency difference between the output frequencies of the syntonisation circuitries of the two satellites may be expressed as ΔF=β×P×(F₂−F₁), where β=v/c (with v being the relative velocity and c the speed of light), P the frequency multiplication factor, and F₁ and F₂ the frequencies of the master oscillators aboard the two satellites.

The nominal frequencies of the master oscillators F₁ and F₂ may be chosen to have the same value, and therefore, the actual difference F₂-F₁ may be small, only driven by effects like aging. Assuming the same type of device is used for both master oscillators, the worst-case frequency difference may be given by F₂-F₁=Ex (F₁+F₂), with E (Hz/Hz) being the relative frequency stability of each of the master oscillators. With this, the frequency residual becomes ΔF=β×E×P×(F₁+F₂′). Since Fₒᵤₜ=P×(F₁+F₂′), then ΔF≈β×E×Fₒᵤₜ, and hence the relative output frequency stability can be written as ΔF/Fₒᵤₜ˜β×E. This shows that, similarly to the phase residual in the short time scales, the relative frequency residual between the output frequencies in the longer time scales does not relate to the parameter P. Instead, it may only depend on the frequency stability of the master oscillators E and the relative velocity between the two satellites (in β=v/c). Therefore, if a particular output frequency is desired for a particular application, if P increases, then the frequency of the master oscillators may have to be decreased (and vice versa) in order to maintain the output frequency equal.

Interestingly, the equation ΔF/Fₒᵤₜ˜β×E indicates that the frequency stability of the syntonisation circuitry's output frequency is much better (B is typically β<5×10⁻⁵) than the stability of the individual master oscillators E. Moreover, the lower the relative speed between the two satellites, the better the stability of the output frequency.

Numerical Example of the Level of Syntonisation Assume two master oscillators at the same nominal frequency of F₀=25 GHz, with opposite long-term stabilities of E=+10⁻⁸, which may be typical for an oven-controlled crystal oscillator. Then F₁=(1+10⁻⁸)×F₀ and F₂=(1-10⁻⁸)×F₀. Therefore, after a few years, the frequency difference between the local oscillators may build-up to 2×10⁻⁸×25 GHZ=500 Hz, and assuming a frequency multiplication factor of P=2, the generated output frequencies may be of the order of Fₒᵤₜ=2×(F₁+F₂′)=100 GHz. For a relative velocity of 15 km/s (extreme case of 2 satellites in Low Earth Orbit flying in opposite direction), the B factor amounts to β=15/(3×10⁵), yielding a frequency difference between the 100 GHz generated outputs of ΔF=2×β×500 Hz=0.05 Hz. This is equivalent to having a frequency stability for long time scales of 0.05/100×10⁹=5×10⁻¹³. Furthermore, a more realistic relative velocity of about 1 km/s would lead to more than one order of magnitude better stability, i.e., 3×10⁻¹⁴, over the same long time scales. This represents an improvement of almost 6 orders of magnitude over the initial stability of the master oscillators thanks to the β factor.

### Harmonics and Inter-Modulation Products Mitigation

This section discusses interference from harmonics and inter-modulation products of the inputs to the mixers generated at their outputs. Taking into account that F₁˜F₂˜F₀ and the Doppler shift due to transmission over the ISL is much smaller than F₀, the inputs to MIX-A may be P×F₀ as local oscillator (LO) and F₀′ as intermediate frequency (IF). In the example case of P=2, the desired output of MIX-A (which output is in the domain of mixers also referred to as the radio frequency output, in short RF) is the USB centred at a frequency of about 3×F₀, but some harmonics and/or inter-modulation products of the LO and IF inputs also fall in the band of interest. The harmonics of the LO input fall safely at 4×F₀, 6×F₀,8×F₀ . . . but those of the IF input are situated at 2×F₀, 3×F₀,4×F₀ . . . , with the third harmonics (3×F₀) coinciding with the USB.

A similar situation happens with MIX-B, where the desired RF output may be at 4×F₀, the harmonics of the LO at 6×F₀, 9×F₀, . . . which do not interfere, yet the 4th harmonic of the IF (2×F₀, 3×F₀, 4×F₀, . . . ) does interfere. Moreover, some inter-modulation products (like for example 2×LO−2×IF) also fall in the band of interest.

To suppress the harmonics of the IF and LO inputs at the RF output, a double-balanced mixer may be used. Such device is a standard microwave component that largely attenuates the harmonics of both IF and LO inputs appearing at the RF output, in particular the potentially harmful third harmonic of the IF input in MIX-A. The amplitude of the harmonics and inter-modulation products generated by this type of mixer are small if the right power ratio of the LO to the IF is fulfilled. Also, in general the amplitude of the unwanted signals is smaller the higher the multiplier value P.

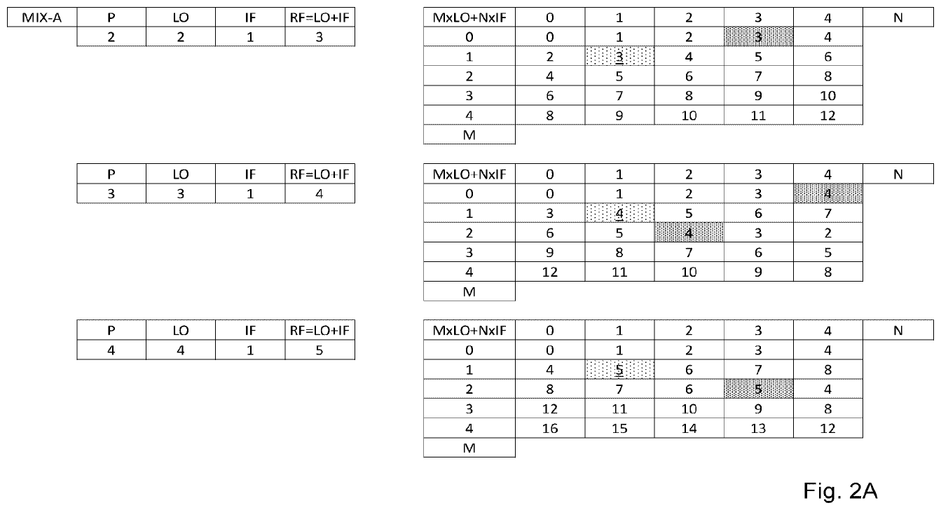

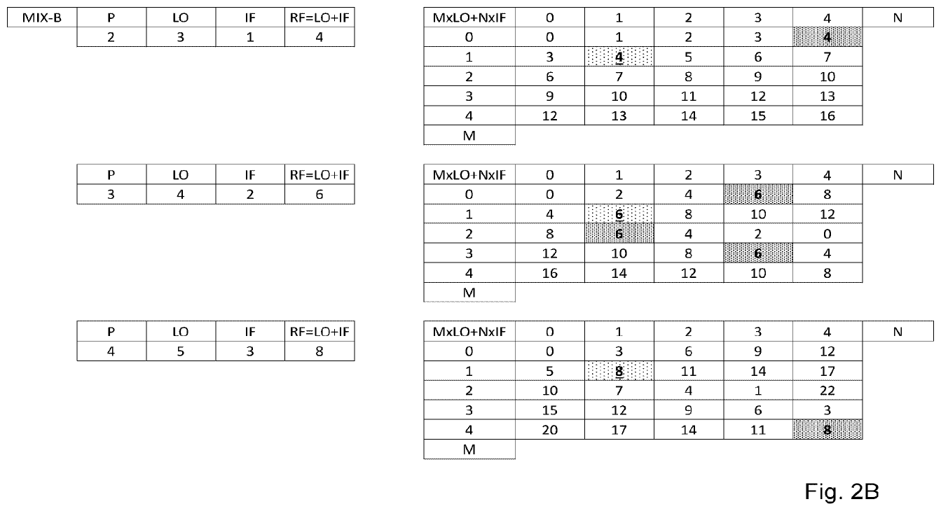

FIGS. 2A and 2B show the frequency of interest (normalised to F₀) and the most harmful harmonics and inter-modulation products for values of P=2,3,4 at the outputs of both mixers, MIX-A (FIG. 2A) and MIX-B (FIG. 2B). Increasing the value of P also increases the order of the interfering signals, having expectedly decreasing amplitudes. Therefore, a suitable selection of parameter P allows reducing unwanted signals at the output. From the tables shown in FIGS. 2A and 2B, it can be seen that even values of P provide a larger separation of the harmful signals than odd values of P, and may thus be preferred, starting with P=2. Also, it can be seen that, for even values of P, the potential interferences at MIX-A output have in general a lower order than those at the output of MIX-B, making the mixer MIX-A the most critical one.

The design of the Upper Side Band filters FIL-A1, FIL-B1 may then be relatively straightforward because of the spectral separation between the wanted signal and the closest harmonics or inter-modulation products. For example, for P=2, the wanted signal at the output of MIX-A may be 3×F₀ while the harmonics fall at 2×F₀ and 4×F₀, yielding a spectral separation of 33%, facilitating the design of the filter FIL-A1.

### Inter-Satellite Link Considerations

SAT-1 may modulate carrier C₁ with the master oscillator frequency F₁ in the modulator MOD-1. Several modulation approaches may be used. As an example, and without loss of generality, an amplitude modulation may be chosen. The modulated signal transmitted from SAT-1 to SAT-2 by Tx-1 may then be expressed as follows, t being the transmission time:

$${T}_{12} ( t ) = [ 1 + A cos ( 2 π {F}_{1} t + {φ}_{1} ) ] cos ( 2 π {C}_{1} t + {ϕ}_{1} )$$

This signal may be received by Rx-2 in SAT-2 after the fly-time over the separation distance r(t) between the two satellites. The received signal is then:

$${R}_{21} ( t ) = {T}_{12} ( t - \frac{r}{c} ) = [ 1 + A cos ( 2 π {F}_{1} ( t - \frac{r}{c} ) + {φ}_{1} ) ] cos ( 2 π {C}_{1} ( t - \frac{r}{c} ) + {ϕ}_{1} )$$

The demodulator DEM-2 in SAT-2 may recover the carrier and demodulate the signal by down-converting the received signal with the recovered carrier:

$${R}_{21} ( t ) \times cos ( 2 π {C}_{1} ( t - \frac{r}{c} ) + {ϕ}_{1} )$$

After low pass filtering and removing the average value, the output of DEM-2 becomes:

$${D}_{21} ( t ) = A cos ( 2 π {F}_{1} ( t - \frac{r}{c} ) + {φ}_{1} )$$

The frequency of the demodulated signal is therefore F₁′=F₁ (1+β), with β=v/c, and v=−dr/dt being the radial velocity. It is preferred that in the demodulation of the signal received at SAT-2 from SAT-1, R₂₁(t), none of the frequencies locally generated in SAT-2 are used, as otherwise the syntonisation may be negatively affected. Furthermore, it is preferred that carrier frequencies C₁ and C₂ are sufficiently spaced apart to avoid interference between transmission and reception.

B) N-Satellite Syntonisation with Relaying

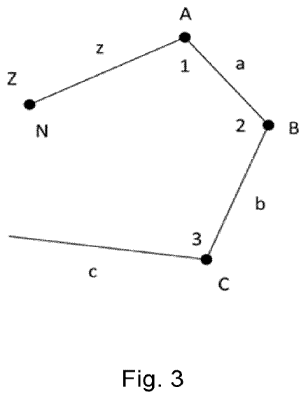

In case of syntonisation between more than two satellites, which more than two satellites may in the following simply be referred to as N satellites, local oscillator signals may be exchanged between the satellites so that each satellite receives the oscillator signals of all other satellites. This may for example by accomplished by establishing a bidirectional ISL between satellites 1 and 2, then another bidirectional ISL between satellites 2 and 3, and so on, with the last ISL being established between the pair of satellites N and 1, closing a loop through all satellites as shown in FIG. 3.

In such a loop, a satellite i may transmit its local oscillator signal to satellite i+1 while additionally relaying all signals from all other satellites (except that from satellite i+1) that satellite i receives from satellite i−1. Similarly, in the other direction of the loop, satellite i+1 may transmit to satellite i its local oscillator signal while additionally relaying to satellite i all signals from all other satellites (except that from satellite i) that satellite i+1 receives from satellite i+2. Such signals of other satellites may here and elsewhere also be referred to as ‘frequencies’ of other satellites as each signal may comprise an oscillator signal generated by a master oscillator of another satellite set to a nominal frequency. In other words, the term ‘frequency of a satellite’ may refer to the (received version of) the oscillator signal generated by a satellite.

This syntonisation between N satellites may be further explained with the support of FIG. 3 and neglecting second order effects (such as the Doppler shift of the Doppler shift or the additional Doppler shift due to the flight times of the signals). Uppercase letters are used to denote the frequencies of the master oscillators aboard each of the satellites while lowercase letters refer to their associated Doppler shift. With continued reference to FIG. 1, satellite 1 may receive from satellite N the following frequencies by ISL link (clockwise around the loop of FIG. 3):

$$B + b + c + … + z \\ C + c + … + z \\ … \\ Z + z$$

and from satellite 2 the following frequencies (counter-clockwise):

$$B + a \\ C + b + a \\ … \\ Z + y … + b + a$$

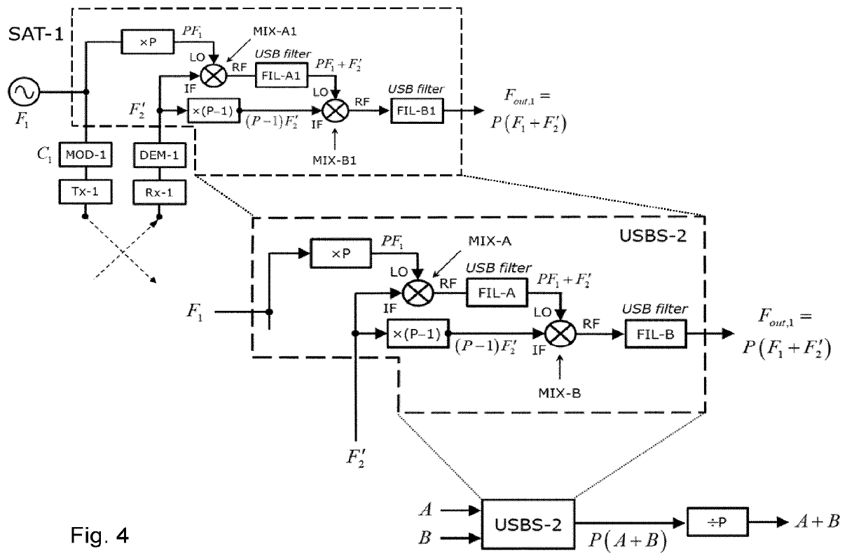

At satellite 1, a sum frequency component may then be generated as follows. The syntonisation circuitry originally described with reference to FIG. 1, which is shown in FIG. 4 in the top left inset, may be configured to add together local and remote frequencies F₁ and F₂′ respectively and may produce their sum frequency multiplied by the factor P at the output, i.e., providing as the output P×(F₁+F₂′). This circuitry, which is shown in the dashed box drawn in FIG. 4, may be used as a module which may be configured to, from two very similar input frequencies A and B, generate a signal of frequency P×(A+B) at its output. This module may also be referred to as USBS-2, referring to an upper side band syntonisation module accepting two inputs. A frequency divider by P at the output of the USBS-2 module yields the sum frequency A+B. Using USBS-2 modules and by-P frequency dividers, the following frequency additions may be performed by the syntonisation circuitry of satellite 1:

$$( B + b + c + … + z ) + ( B + a ) = 2 B + a + b + c + … + z \\ … . \\ ( Z + z ) + ( Z + y + … + b + a ) = 2 Z + a + b + c + … + z$$

Here and elsewhere, the term ‘frequency addition’ is used synonymously with ‘frequency summation’; the output of a frequency addition is a sum frequency.

These N−1 frequencies may be further added up sequentially as follows:

$$( 2 B + a + b + c + … + z ) + ( 2 C + a + b + c + … + z ) = 2 ( B + C ) + 2 ( a + b + c + … + z ) \\ 2 ( B + C ) + 2 ( a + b + c + … + z ) + ( 2 D + a + b + c + … + z ) = 2 ( B + C + D ) + 3 ( a + b + c + … + z ) \\ …$$

where for the first addition above, one USBS-2 module and one by-P frequency divider may be used. The resulting frequency after the sequential addition of the N−1 frequencies is:

$$2 ( B + C + … + Z ) + ( N - 1 ) ( a + b + c + … + z )$$

It is noted that the above-described sequential additions may also be carried out by a binary tree of pair-wise additions using the USBS-2 module.

To this frequency, satellite 1 may add twice its own local frequency to complete the expression, which becomes:

$$2 ( A + B + C + … + Z ) + ( N - 1 ) ( a + b + c + … + z )$$

Similarly, satellite 2 may receive from satellite 1 the following frequencies by ISL link (clockwise around the loop of FIG. 3):

$$C + c + d + … + z + a \\ D + d + … + z + a \\ … \\ Z + z + a \\ A + a$$

and from satellite 3 (counter-clockwise):

$$C + b \\ D + c + b \\ … \\ Z + y … + b \\ A + z + y … + b$$

Adding frequency pairs using USBS-2 modules and by-P frequency dividers, as for satellite 1, gives:

$$( C + c + d + … + z + a ) + ( C + b ) = 2 C + a + b + c + … + z \\ … \\ ( Z + z + a ) + ( Z + y … + b ) = 2 Z + a + b + c + … + z \\ ( A + a ) + ( A + z + y … + b ) = 2 A + a + b + c + … + z$$

And adding all frequencies plus twice the local frequency of satellite 2 yields:

$$2 ( A + B + C + … + Z ) + ( N - 1 ) ( a + b + c + … + z )$$

which is the same frequency as that generated in satellite 1. Proceeding in the same manner, the syntonisation of the whole constellation, i.e., the whole system of N satellites, may be achieved as all N satellites generate the same sum frequency Fₒᵤₜ using their respective syntonisation circuitry, with Fₒᵤₜ being given by:

$${F}_{out} = 2 S + ( N - 1 ) s$$

where S is the sum of the frequencies of the individual master oscillators of all the satellites (S=A+B+ . . . +Z) and s the sum of their Doppler shifts (s=a+b+ . . . +z).

### Consideration of Flight Times

The previous section assumed that the speed of light is infinite so that flight times of signals between satellites are zero. In the following, the effect of the finite nature of the speed of light is considered.

As an example, consider the reception by satellite 1 of the frequency B+b+c+ . . . +z from satellite N. This signal was first transmitted by satellite 2 towards satellite 3, then relayed by satellite 3 towards satellite 4, and so on successively until the signal arrived satellite 1. The distance travelled by the signal has therefore been the path from satellite 2 to satellite 1 going through all other satellites.

To quantify the path length, and without loss of generality, one may assume that all satellites have a similar orbital radius R. Then, the maximum path length is given by 2(N−1)R, corresponding to a flight time of T=2 (N−1) R/c, with c being the speed of light. One may further assume R=26,000 km and N=30, those being the typical radius and number of satellites of GNSS constellations, respectively. Then T=5 s. This sets the range of time scales in which the equations of the previous section hold: as long as the frequencies of the master oscillators A, B . . . Z, and the Doppler shifts a, b . . . z do not change significantly during 5 seconds, then the equations of the previous section hold. The degradation in the similarity of the syntonisation frequency due to the T=5 s maximum flight time would be absorbed by using a factor 5 more stable master oscillators, which is a realistic option. The impact of the flight time on the Doppler shift is also negligible. To prove this, consider that the gravity for an orbit of radius R is given by g_{E}=GM/R² (i.e., g_{E}=0.6 m/s² at R=26,000 km) and therefore, the maximum relative change of Doppler in T seconds can never exceed 2T×sqrt(g_{E}/R), that is, 2×5×sqrt(0.6/26×10⁶)=1.1×10⁻³. Therefore, the flight time impact only amounts to no more than one thousandth and can safely be neglected.

In conclusion, the equations of the previous section, which disregarded the flight times of signals between satellites, are therefore deemed to hold.

### Block Diagram

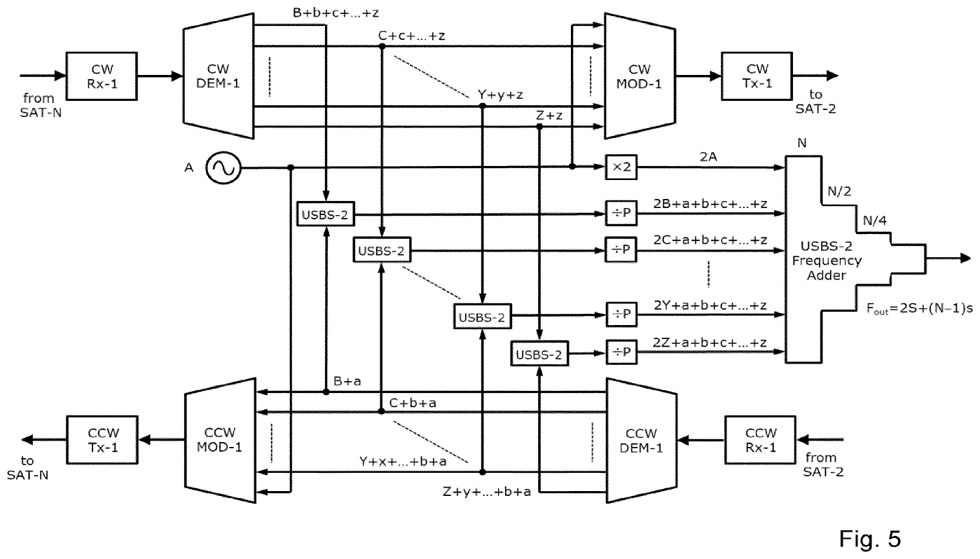

FIG. 5 is the block diagram of the syntonisation circuitry of satellite 1 for the syntonisation between N satellites. In this example, and with continued reference to FIG. 3, satellite N may be located counter-clockwise (to the left) of satellite 1 in the loop while satellite 2 may be located clockwise (to the right) of satellite 2 in the loop.

The upper part of FIG. 5 relates to the inter-satellite links in the clockwise direction (from satellite N to satellite 1, from satellite 1 to satellite 2, and so on), which may elsewhere simply be referred to as clockwise (CW) links. The receiver CW-Rx-1 may receive the modulated signals transmitted by satellite N in the clockwise direction, i.e., transmitted towards satellite 1. The demodulator CW DEM-1 outputs the received versions of the oscillator signals at their respective frequencies. These signals, except the signal containing frequency B of satellite 2, together with the signal representing the master oscillator frequency A of satellite 1, may be relayed towards satellite 2 using the clockwise modulator CW MOD-1 and transmitter CW Tx-1.

The lower part of FIG. 5 relates to the inter-satellite links in the opposite, counter-clockwise direction (from satellite 2 to satellite 1, from satellite 1 to satellite N, and so on), which may elsewhere simply be referred to as counter-clockwise (CCW) links. The receiver CCW-Rx-1 may receive the modulated signals transmitted by satellite 2 in the counter-clockwise direction, i.e., transmitted towards satellite 1. The demodulator CCW DEM-1 outputs the received versions of the oscillator signals at their respective frequencies. All signals, except the signal containing frequency Z of satellite N, together with the signal representing the master oscillator frequency A of satellite 1, may be relayed by satellite 1 towards satellite N using the counter-clockwise modulator CCW MOD-1 and transmitter CCW Tx-1.

The middle part of FIG. 5 shows the frequency addition using USBS-2 modules and by-P frequency dividers as needed. A first layer of additions comprises the pair-wise addition of corresponding signals received via the CW and CCW links, meaning the signals containing the oscillator signals of a particular satellite as received via the CW link and the CCW link. An example of such a pair is the signal B+b+C+ . . . +Z received via the CW link and the signal B+a received via the CCW link, with both signals pertaining to satellite 2 having master oscillator B. This first layer of additions results in a number of outputs which respectively contain the frequencies 2B+s, 2C+s, 2Z+s (s being the sum of all Doppler shift frequencies). These output signals and the twice the master oscillator frequency of satellite 1, 2A, may enter a frequency adder module whose function is to complete the frequency addition, using USBS-2 modules as required. This could be performed, for example, by several stages of pair-wise additions of intermediate outputs of USBS-2 modules, e.g., in a binary tree manner.

The output of the frequency adder may be a signal at the desired syntonisation frequency: Fₒᵤₜ=2S+(N−1) s. The output signal Fₒᵤₜ may then be used for application purposes, e.g., as a common clock in cooperative space applications.

### Inter-Satellite Link Considerations

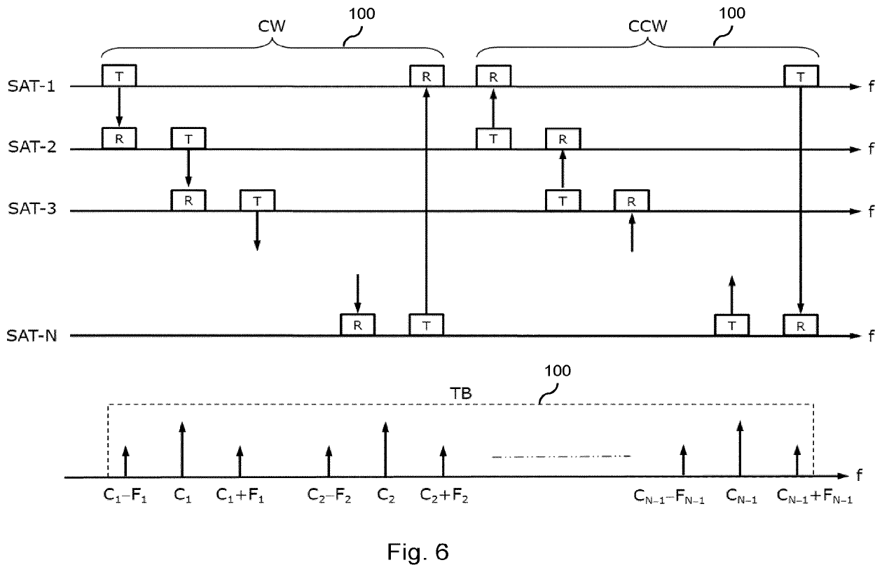

The syntonisation of N satellites may involve at least two ISLs per satellite, each involving the transmission and reception of N−1 signals of other satellites. As in the case of 2 satellites, the ISLs may have to be designed to ensure enough spectral separation between the transmission and reception bands to avoid electromagnetic interference. Also, the demodulation is preferably implemented without using any reference frequency generated at the satellite, that is, by methods that allow recovering the modulation signal as received (for example, using the carrier recovered from the received signal itself for the demodulation, or using amplitude modulation at transmission and an amplitude detector at reception, etc.). In this scheme, each of the N−1 signals may represent a locally generated oscillator signal modulating a separate carrier. As such, the modulator may have to generate N−1 carriers modulated by the corresponding signals. This is illustrated in FIG. 6. Here, the top-part of FIG. 6 shows one possible way on how the transmission and reception frequency bands of the ISLs can be organized to avoid cross talk, while the bottom part of FIG. 6 shows a generic transmission spectrum of the N−1 modulated carriers. It is noted that the implementation of the ISLs may be done in the RF as well as in the optical domain.

### Absolute Drift of the Syntonisation Frequency

The syntonisation frequency may vary with respect to an absolute reference standard due to two reasons: the added contribution of the temporal drifts of all local master oscillators (term S=A+B+ . . . +Z) and the sum of the time evolution of the Doppler shifts (term s=a+b+ . . . +z). Such drifting away of the syntonisation frequency due to the temporal drift of the term S may be avoided by disciplining the master oscillators aboard the satellites to an atomic reference on ground by applying a type of ground-to-space frequency transfer. Such frequency transfer may have to be performed for each of the N satellites and may have to be repeated periodically. The repetition rate of the frequency transfer would depend on the maximum deviation allowed of the syntonisation frequency from the absolute reference standard.

The variation of the syntonisation frequency with the temporal evolution of the sum of the Doppler shifts may be much mitigated by fundamentally designing the constellation of the N satellites and the path of the ISLs to achieve s=0. There are many solutions to designing a constellation such that the constellation achieves s=0, meaning that the syntonisation frequency will experience no temporal evolution due to the sum of the Doppler shifts s because they add to zero by design.

### Syntonisation and Synchronisation

All N satellites may be syntonised as explained above, i.e., their syntonisation circuitry causes them to generate the same frequency. If time is measured from their syntonised frequency, then all satellites will measure substantially the same time, except for a constant number of periods (the period being the inverse of the syntonisation frequency). This constant offset could eventually determined by synchronization techniques based on known time transfer techniques.

C) N-Satellite Syntonisation with One-to-all Transmissions

The N-satellite syntonisation may also be carried out using so-called one-to-all transmissions instead of one-to-one transmissions as those used to establish the clockwise and counter-clockwise loops of inter-satellite links explained in the embodiments discussed in the previous sections and identified by the heading ‘B’.

In the one-to-all transmission scheme, one satellite may transmit a signal which may be received by all of the other N satellites. In such a one-to-all transmission scheme, preferably a wide enough radiation pattern should be used for the signal to reach each of the other satellites. Nevertheless, as also explained later, it may be that only some of the satellites may have to receive the signal transmitted by a particular transmitting satellite, which means that the radiation pattern may not need to reach all of the other satellites.

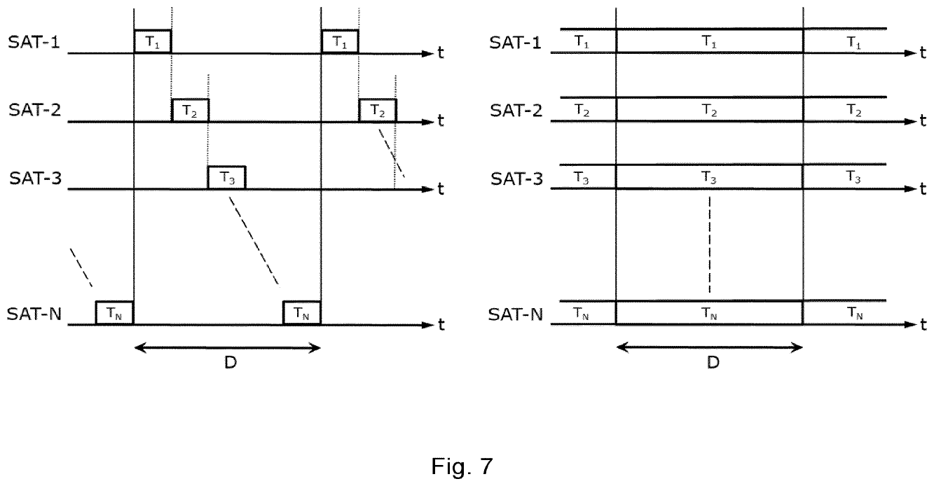

The following describes embodiments belonging to the latter category. Here, it is assumed that the N satellites are time synchronised by some means, as for example in the case of the satellites being part of a GNSS. The time synchronisation may be needed if transmission and reception windows are used which are scheduled according to a time scale, in which case it is preferred that the time scale is the same for all satellites. This may for example be explained with reference to FIG. 7, which shows satellite 1 being scheduled to transmit during the transmission window T1, satellite 2 to transmit during T2, and so on so forth. After all N satellites have transmitted at least once, a new period of transmissions starts, which may or may not follow the same pattern. It is noted that the time duration D at which transmissions from each satellite are repeated is preferably short enough to achieve an adequate frequency syntonisation; the corresponding condition will be established later. In general, during the time interval D, any of the satellites may transmit in more than one transmission window. The transmission windows may in general overlap. If they do, different carrier frequencies may be used in the overlapping transmission windows. If the transmission windows do not overlap, the transmissions may use the same carrier.

As indicated earlier, in some one-to-all transmission schemes, not all satellites may receive the signals transmitted by one particular satellite. A satellite that activates its receiver at the moment of the transmission of another satellite is said to be in listening mode. In the one-to-all transmission scheme which is further described in the following, whenever satellite 1 transmits, satellite N and satellite 2 go into listening mode, while the rest of the satellites neglect the transmissions by satellite 1. Here, it is assumed that the satellites are represented by the loop of FIG. 3, and that satellites which are directly neighbouring in the loop are within each others transmission and reception range. Furthermore, when satellite 2 transmits, only satellites 1 and 3 go into listening mode, and so on so forth until the moment satellite N transmits and only satellites N−1 and 1 go into listening mode. Depending on the number of overlapping transmission windows, more or fewer satellites will be in listening mode.

Every satellite may have two sets of N−1 disciplined oscillators. The first set may be disciplined to the frequencies of the master oscillators of the other satellites, affected by the Doppler shifts in the clockwise direction. The second set may be similar to the first one but may be disciplined to the frequencies of the master oscillators of the other satellites, affected by the Doppler shifts in the counter-clockwise direction. The frequencies of the two sets of N−1 discipline oscillators of satellite 1 may be:
Z+z, Y+y+z, X+x+y+z, . . . , C+c+d+ . . . +z, B+b+c+ . . . +z (clockwise set) B+a, C+b+a, D+c+b+a, . . . , Y+x+ . . . +a, Z+y+ . . . +a (counterclockwise set)

During transmission, satellite 1 may transmit all above frequencies, except for the last one of each set (B+b+c+ . . . +z and Z+y+ . . . +a), plus the frequency of its master oscillator A. When satellite 1 transmits, satellite 2 may activate its clockwise receiver to receive the clockwise set above, and satellite N may activate its counter-clockwise receiver to receive the counter-clockwise set. All other satellites may be configured to ignore the transmission of satellite 1. By propagating the same operation to all N satellites, it can be seen that satellite 1 may receive all the frequencies of the clockwise set every time satellite N makes a transmission, and all frequencies of the counter-clockwise set when satellite 2 makes a transmission. This allows satellite 1 to keep its discipline oscillators tuned to their expected frequencies.

Satellite 1 may now add pairs of frequencies, one of each set (clockwise and counter-clockwise), using the USBS-2 module as explained elsewhere and followed by the by-P frequency dividers to obtain:

$$( B + b + c + … + z ) + ( B + a ) = 2 B + a + b + c + … + z \\ ( C + c + … + z ) + ( C + b + a ) = 2 C + a + b + c + … + z \\ … . \\ ( Z + z ) + ( Z + y + x + … + a ) = 2 Z + a + b + c + … + z$$

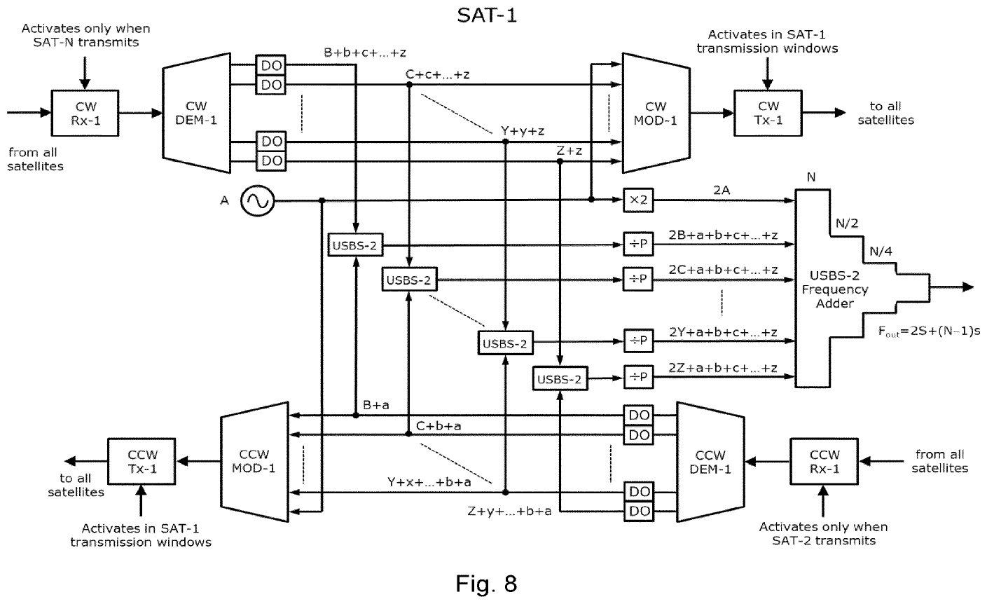

and proceeding as in the embodiments B, the syntonisation frequency 2S+(N−1) s may be generated by adding all frequencies including 2A, where this frequency addition can be accomplished using USBS-2 modules as needed. FIG. 8 shows a block diagram of the corresponding syntonisation circuitry of satellite 1.

### Considerations on the Periodicity of Transmissions

The disciplined oscillators may be oscillators whose output frequency equals the frequency of an input signal when this is available, for example when a transmission by another satellite is ongoing, and when such an input signal is not available, for example because its transmission has been stopped, then the oscillator may strive to keep the frequency as stable as possible. Such disciplined oscillators are known per se and may for example take the form of a voltage-controlled oscillator in conjunction with a digital circuit which controls the voltage controller oscillator.

The deviation of the output frequency of the disciplined oscillators from the desired value may increase the longer the transmission windows of the frequencies are spaced apart, e.g., by the duration D as previously shown in FIG. 7 on the left-hand side. Alternatively, the satellites may transmit continuously, as shown in FIG. 7 on the right-hand side. In such a case, disciplined oscillators may not be needed, but the transmissions should use different carriers so as to avoid disturbing each other.

If the transmission windows are adjacent to each other without overlap (as in FIG. 7, left), the duration D over which all N satellites have transmitted their signal at least once must be short enough so that the accumulated drift of the master oscillators frequencies (A, B, C . . . Z) and their Doppler shifts (a, b, c . . . z) is small. Taking into account the computations in the previous section, and assuming gravitational forces dominate the satellite motion, then D may preferably be below 5 seconds.

### Example: Syntonisation of 4 Cubesats in Close Formation

For illustration, consider 4 CubeSats at close range (i.e., at a separation of less than 100 km) that need to be syntonised to perform beamforming for GNSS reflectometry at L1/E1=1575 MHz. Each of the CubeSats may be equipped with a GNSS receiver and a 10 MHz master oscillator. The master oscillators may be assumed of the Temperature Compensated Crystal Oscillators (TCXO) type, with a short-term stability better than 10⁻⁹. The CubeSats may synchronise their on-board computers to GNSS-time to better than 10 us by straightforward means. The transmission scheme with adjacent non-overlapping transmission windows (FIG. 7, left) may be selected. The length of the transmission window, for example 5 ms, may be chosen to be much longer than the maximum possible flight time of 0.3 ms (corresponding to a maximum satellite separation of 100 km). The corresponding repetition period is of D=20 ms. Because the transmission windows do not overlap, the same carrier may be used in all inter satellite transmissions, and all receivers may be made identical, tuned to that same frequency.

Each CubeSat may carry three additional 10 MHz oscillators disciplined to the master frequencies of the other 3 satellites as described above. The disciplined oscillators may be refreshed once every repetition period of D=20 ms. The syntonisation frequency may be about 40 MHz. The drift between updates may cause an average impact at the L1/E1 frequency of no more than (10−9)×(1575×10+6 Hz)×0.02 s/2=0.015 cycles (about 0.1 radian). The maximum relative change of the Doppler shifts over the repetition period is of 2D×sqrt(g_{E}/R), which, for a LEO of 500 km altitude yields 2×0.02×sqrt(9.8/6870×10+3)=4.8×10−5, a contribution which can be safely neglected. The four CubeSats may thus operate syntonised with an error of less than 0.1 radian, regardless of their relative speeds, and may perform beamforming at L1/E1 GNSS reflectometry.

It is noted that the syntonisation circuitry described in this specification may be implemented in any known manner, e.g., using microwave components but also in the digital domain. An example of the latter is that the receiver and transmitter defined in this specification may be implemented in form of a software-defined radio. Similarly, functions such as the frequency multiplier, mixers, upper-side band filters, etc. may be implemented in software as well. Such software components may then be executed on general purpose hardware, or may be converted to application-specific hardware, e.g., to an ASIC or FPGA. In general, a combination of general-purpose hardware and application-specific hardware may be used, or a combination of digital domain hardware and microwave components, etc.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or stages other than those stated in a claim. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A vehicle configured to generate an internal signal having a frequency which is syntonised with the frequency of the internal signal generated by a second vehicle, wherein the vehicle comprises:
a first master oscillator configured to oscillate at a nominal frequency and to generate a first oscillator signal (F₁) at the nominal frequency;
a receiver (Rx-1) configured to receive an inter-vehicle signal, wherein the inter-vehicle signal is generated by the second vehicle by modulating a carrier (C₂) with a second oscillator signal (F₂), wherein the second oscillator signal is generated by a second master oscillator of the second vehicle, wherein the second master oscillator is configured to oscillate at the nominal frequency; and
signal processing circuitry configured to:
demodulate the received inter-vehicle signal to obtain a demodulated signal comprising a received version of the second oscillator signal (F₂′);
generate the internal signal based on a sum frequency comprising the first oscillator signal (F₁) and the received version of the second oscillator signal (F₂′) as summands.

2. The vehicle according to claim 1, wherein the signal processing circuitry comprises a module (USBS-2) for use in generating the internal signal, wherein the module is configured to generate a frequency-multiplied sum frequency for a first input signal as a first summand and a second input signal as a second summand by:
frequency-multiplying the first input signal (F₁) by a first multiplier value (P), which first multiplier value is a natural number larger than one, to obtain a frequency-multiplied first input signal (PF₁);
frequency-multiplying the second input signal (F₂′) by a second multiplier value (P−1), which second multiplier value equals the first multiplier value minus one, to obtain a frequency-multiplied second input signal ((P−1)F₂′);
mixing the frequency-multiplied first input signal (PF₁) with the second input signal (F₂′) and applying an upper side band filter to an output of said mixing to obtain an intermediate upper side band-filtered signal (PF₁+F₂′); and
mixing the intermediate upper side band-filtered signal (PF₁+F₂′) with the frequency-multiplied second input signal ((P−1)F₂′) and applying an upper side band filter to an output of said mixing to obtain the frequency-multiplied sum frequency (P(F₁+F₂′)).

3. The vehicle according to claim 2, wherein the signal processing circuitry is configured to generate the frequency-multiplied sum frequency (P(F₁+F₂′)) using the first oscillator signal (F₁) as the first input signal and the received version of the second oscillator signal (F₂′) as the second input signal.

4. The vehicle according to claim 2- or 3, wherein the signal processing circuitry is configured to use the frequency-multiplied sum frequency P (F₁+F₂′)) as the internal signal.

5. The vehicle according to claim 1, further comprising a transmitter (Tx-1) configured to transmit a second inter-vehicle signal to the second vehicle, wherein the signal processing circuitry is configured to generate the second inter-vehicle signal by modulating a carrier (C₁) with the first oscillator signal (F₁).

6. The vehicle according to claim 5, wherein the carrier (C₁) used by the vehicle is different from the carrier (C₂) used by the second vehicle, for example in frequency.

7. The vehicle according to claim 2, wherein the vehicle is configured to receive an inter-vehicle signal of a third vehicle, wherein the received inter-vehicle signal is generated by the third vehicle by modulating a carrier (C₃) with a third oscillator signal (F₃) generated by a third master oscillator, and wherein the signal processing circuitry is further configured to generate the internal signal based on the sum frequency (F₁+F₂′+F₃′) comprising the first oscillator signal (F₁), the received version of the second oscillator signal (F₂′) and a received version of the third oscillator signal (F₃′) as summands.

8. The vehicle according to claim 7, wherein the signal processing circuitry is configured to generate the sum frequency (F₁+F₂′+F₃′) by using the module (USBS-2) with pairs of oscillator signals of master oscillators of different vehicles as input to obtain respective intermediate outputs and to repeatedly use the module with pairs of previous intermediate outputs so as to obtain the sum frequency as output.

9. The vehicle according to claim 8, wherein the signal processing circuitry is configured to frequency-divide each output of the module (USBS-2) by the first multiplier value (P).

10. The vehicle according to claim 7, wherein the inter-vehicle signal of the third vehicle is received directly from the third vehicle or is received by relay via the second vehicle.

11. The vehicle according to according to claim 1, wherein the first multiplier value (P) is an even number.

12. The vehicle according to according to claim 1, wherein the inter-vehicle signal is an optical signal or a radio-frequency signal.

13. The vehicle according to claim 1, wherein the vehicle is a space vehicle, such as a satellite, or an aerial vehicle, such as an unmanned aerial vehicle.

14. A system of vehicles, wherein each vehicle of the system of vehicles is a vehicle according to claim 1.

15. A method of generating, at a vehicle, an internal signal having a frequency which is syntonised with the frequency of the internal signal generated by a second vehicle, wherein the vehicle comprises:
a first master oscillator configured to oscillate at a nominal frequency and to generate a first oscillator signal (F₁) at the nominal frequency;
a receiver (Rx-1) configured to receive an inter-vehicle signal, wherein the inter-vehicle signal is generated by the second vehicle by modulating a carrier (C₂) with a second oscillator signal (F₂), wherein the second oscillator signal is generated by a second master oscillator of the second vehicle, wherein the second master oscillator is configured to oscillate at the nominal frequency; and
wherein the method comprises:
demodulating the received inter-vehicle signal to obtain a demodulated signal comprising a received version of the second oscillator signal (F₂′);
generating the internal signal based on a sum frequency comprising the first oscillator signal (F₁) and the received version of the second oscillator signal (F₂′) as summands.
